(19) United States
(12) Patent Application Publication
(10) Pub. No.: US 2019/0069053 A1
(43) Pub. Date: Feb. 28, 2019

(54) EFFICIENT ENERGY MANAGEMENT FOR WIRELESS PRESSURE INDICATION SYSTEMS

(71) Applicant: Goodrich Corporation, Charlotte, NC (US)

(72) Inventors: Sivakumar Laguduwa, Bangalore (IN); Prashant Vadgaonkar, Bangalore, Karnataka (IN); Diptar Banik, Bangalore (IN); Santhosh Kumar Venkatachalapathy, Tamilnadu (IN); Chad Sneath, Gilbert, AZ (US)

(21) Appl. No.: 15/788,835

(22) Filed: Oct. 20, 2017

(30) Foreign Application Priority Data
Aug. 25, 2017 (IN) 201711030180

(51) Int. Cl. H04Q 9/00

(52) U.S. Cl. CPC H04Q 9/00; H04Q 2209/883; H04Q 2209/40

(57) ABSTRACT

Embodiments include techniques for efficient energy management for wireless pressure indication systems, the techniques include transmitting, via a wireless pressure sensor (WPS) device, an awake message at a configurable interval, and responsive to receiving a reply message to the awake message, entering an active state. The techniques also include sensing a present condition to obtain sensor information, transmitting the sensor information, and responsive to receiving an acknowledgment message for the sensor information, returning to a sleep state. Embodiments also include techniques for efficient energy management for wireless pressure indication systems, the techniques include receiving, via a wireless pressure indicator device, an awake message, and responsive to the awake message, entering an active state. The techniques also include responsive to receiving sensor information, transmitting an acknowledgement message, and returning to a sleep state.

### BACKGROUND

This application claims the benefit of priority to Indian Application No. 201711030180 filed Aug. 25, 2017, the disclosure of which is incorporated herein by reference in its entirety.

### BACKGROUND

The present invention relates to pressure sensors, and more specifically, to efficient energy management for wireless pressure indication systems.

Prior to taking flight, an aircraft must pass a series of tests and checks to ensure the proper functioning of its systems and the safety of its passengers. These pre-flight checks can include performing tests on the electrical and mechanical systems, emergency systems, checking fluid levels, checking the crew to ensure they are present and accounted for, and more. Some checks can be performed automatically by the aircraft while others are performed manually by crew members and/or other maintenance staff. The information gathered during the pre-flight checks can be used to target areas that may need maintenance or identify abnormal damage to the equipment. These checks are critical to safe operation of the aircraft.

One of the existing checks utilizes a system that monitors aircraft evacuation slide's potential performance in the event of an emergency. Currently, these systems are cumbersome because the air pressure gauges are inconveniently positioned making it difficult for crew members to get accurate reads which can lead to inaccuracies.

### BRIEF DESCRIPTION

According to one or more embodiments, methods for efficient energy management for wireless indication systems are provided. The methods includes transmitting, via a wireless pressure sensor device, an awake message at a configurable interval, responsive to receiving a reply message to the awake message, entering an active state, sensing a present condition to obtain sensor information, transmitting the sensor information, and responsive to receiving an acknowledgment message for the sensor information, returning to a sleep state.

In addition to one or more of the features described herein, or as alternatives, further embodiments of the methods may include the sensor information having at least pressure information, temperature information, and battery information.

In addition to one or more of the features described herein, or as alternatives, further embodiments of the methods may include being responsive to missing the acknowledgment message after transmitting the sensor information, retransmitting the sensor information a configurable threshold number of times prior to returning to the sleep state.

In addition to one or more of the features described herein, or as alternatives, further embodiments of the methods may include being responsive to missing the awake message, waiting a timeout period prior to returning to the sleep state.

In addition to one or more of the features described herein, or as alternatives, further embodiments of the methods may include a plurality of wireless pressure sensor devices being paired with a wireless pressure indicator device.

In addition to one or more of the features described herein, or as alternatives, further embodiments of the methods may include a single wireless pressure sensor device being paired with a wireless pressure indicator device.

In addition to one or more of the features described herein, or as alternatives, further embodiments of the methods may include transmitting the awake message, responsive to receiving a request message.

In addition to one or more of the features described herein, or as alternatives, further embodiments of the methods may include the wireless pressure sensor device being associated with an evacuation slide.

According to one or more embodiments, methods for efficient energy management for wireless indication systems are provided. The methods includes receiving, via a wireless pressure indicator device, an awake message, responsive to the awake message, entering an active state, responsive to receiving sensor information, transmitting an acknowledgement message, and returning to a sleep state.

In addition to one or more of the features described herein, or as alternatives, further embodiments of the methods may include the sensor information having at least pressure information, temperature information, and battery information.

In addition to one or more of the features described herein, or as alternatives, further embodiments of the methods may include a plurality of wireless pressure sensor devices being paired with the wireless pressure indicator device.

In addition to one or more of the features described herein, or as alternatives, further embodiments of the methods may include a single wireless pressure sensor device being paired with the wireless pressure indicator device.

In addition to one or more of the features described herein, or as alternatives, further embodiments of the methods may include the wireless pressure indicator device entering the awake state based on receiving a request.

In addition to one or more of the features described herein, or as alternatives, further embodiments of the methods may include the wireless sensor device being associated with an evacuation slide.

According to one or more embodiments, methods for efficient energy management for wireless indication systems are provided. The systems include a wireless pressure sensor device, wherein the wireless pressure sensor device is coupled to a regulator valve, and a wireless pressure indicator device, wherein the wireless pressure indicator device includes a processor, a display, and a communication interface.

In addition to one or more of the features described herein, or as alternatives, further embodiments of the systems may include the wireless pressure sensor device measuring an air pressure used for evacuation slides.

In addition to one or more of the features described herein, or as alternatives, further embodiments of the systems may include the sensor information having at least pressure information, temperature information, and battery information.

In addition to one or more of the features described herein, or as alternatives, further embodiments of the systems may include a plurality of wireless pressure sensor devices being paired with the wireless pressure indicator device.

In addition to one or more of the features described herein, or as alternatives, further embodiments of the systems may include a single wireless pressure sensor device being paired with the wireless pressure indicator device.

### BRIEF DESCRIPTION OF THE DRAWINGS

The following descriptions should not be considered limiting in any way. With reference to the accompanying drawings, like elements are numbered alike:

FIG. 1 depicts a system for efficient energy management for wireless pressure indication;

FIG. 2 depicts a timing chart for efficient energy management for wireless pressure indication systems;

FIG. 3 depicts a timing chart for efficient energy management for wireless pressure indication systems;

FIG. 4 depicts a timing chart for efficient energy management for wireless pressure indication systems;

FIG. 5 depicts a state diagram for efficient energy management for wireless pressure indication systems;

FIG. 6 depicts a flow chart for operating a wireless pressure sensor for efficient energy management of a wireless pressure system; and

FIG. 7 depicts a flow chart for operating a wireless pressure indicator for efficient energy management of a wireless pressure system.

### DETAILED DESCRIPTION

Existing pressure indication systems for evacuation slides utilize mechanical systems equipped with a mechanical gauge for pressure indication. The pressure indication provided from the system provides an indication whether the evacuation slide is capable of inflating or not during an emergency condition. Currently, the existing systems are cumbersome for crew members to visualize as the air pressure gauge are located in inconvenient positions and also the systems are limited by the accuracy of the mechanical gauge. In one or more embodiments, the techniques described herein provide a wireless pressure indication system to address the above issues.

A detailed description of one or more embodiments of the disclosed apparatus and method are presented herein by way of exemplification and not limitation with reference to the Figures.

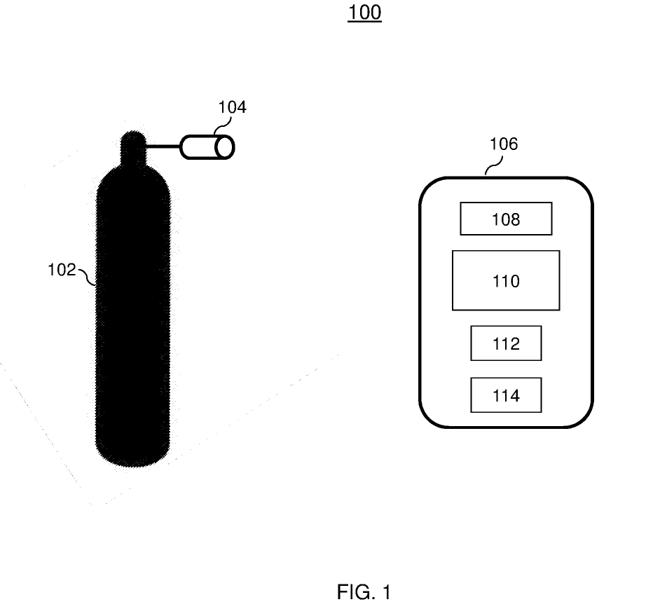

Now referring to FIG. 1, a system 100 for efficient energy management for wireless pressure indication systems is shown.

In one or more embodiments, the system 100 includes at least a wireless pressure sensor (WPS) 104 and wireless pressure indicator (WPI) 106. The WPS 104 and the WPI 106 are configured to communicate wirelessly. The wireless protocols that are used can be any type of known wireless standards such as but not limited to 802.11, 802.15, etc. These standards include Wi-Fi, Bluetooth, and other standards including close range communication techniques. Although, a single WPS 104 is shown in FIG. 1, a plurality of WPS 104 can be coupled to the WPI 106 for communications.

In a current embodiment, the WPS 104 is coupled to a tank 102 used for pressuring devices. In a non-limiting example, the tank 102 can be used to pressurize an evacuation slide of an aircraft. The tank 102 can also be equipped with a regulator valve for controlling the air pressure. The WPS 104 and WPI 106 can be used in other applications. In addition, the WPS 104 can be a different type of sensor that can sense different conditions such as temperature, remaining battery information such as capacity, remaining charge and the like. The WPI 106 includes a processor 108, a communication interface 110, a display 112, and a user switch interface 114. The WPI 106 can also be equipped with other features not shown.

In one or more embodiments, the system 100 can be configured for one-to-one communication. This configuration provides that a single WPS 104 communicates with a single WPI 106. The process of configuring the WPI 106 and WPS 104 to communicate with one another is known as pairing. The pairing process can occur manually by a user and/or automatically by the WPI 106 once a WPS 104 within range has been detected by the WPI 106. After the connection has been established for the devices they are considered to have been “paired” with one another. In one or more embodiments, once the one-to-one communication has been configured, additional WPS 104 can be added and paired with the WPI 106.

In other embodiments, the system 100 can be configured for one-to-many communications having a single WPI 106 communicating with a plurality of WPS 104. This configuration allows WPI 106 to act as a central WPI 106. Also, the WPI 106 is configured to process and display the information received from the one or more WPS 104. The central WPI 106 can add WPS 104 as needed based on the application.

In an example operation, the WPS 104 wakes up at 5 second intervals and sends a signal to the WPI 106 to check if it is awake. If a response is received, the WPS 104 takes a pressure sensor reading and transmit the information to the WPI 106. In one or more embodiments, the transmission can take 300 milliseconds maximum. Responsive to the WPI 106 receiving the transmission, an acknowledgment is transmitted back to the WPS. The acknowledgment signals the WPS 104 to return to sleep state and the WPI 106 is configured to display the pressure sensor reading. The pressure sensor reading can be displayed on a display such as a liquid crystal display (LCD) or the WPI 106 can just indicate if the pressure is ok. Subsequently, the WPI 106 returns to sleep state to conserve the energy of the system. In one or more embodiments, the power of the system can be supplied by a battery.

In a different embodiment, the WPI 106 can be awakened from its system by a remote signal supplied by a device. For example, a user may have a key or a button on the WPI 106 can be pressed and responsive to the signal the WPI 106 will be awakened. In another embodiment, the WPS 104 can be configured to wake up at periodic intervals to determine if the WPI 106 has been awakened due to a request from the remote device or key. A user may provide the request to perform a check to determine whether there is adequate pressure for inflation of the evacuation slide.

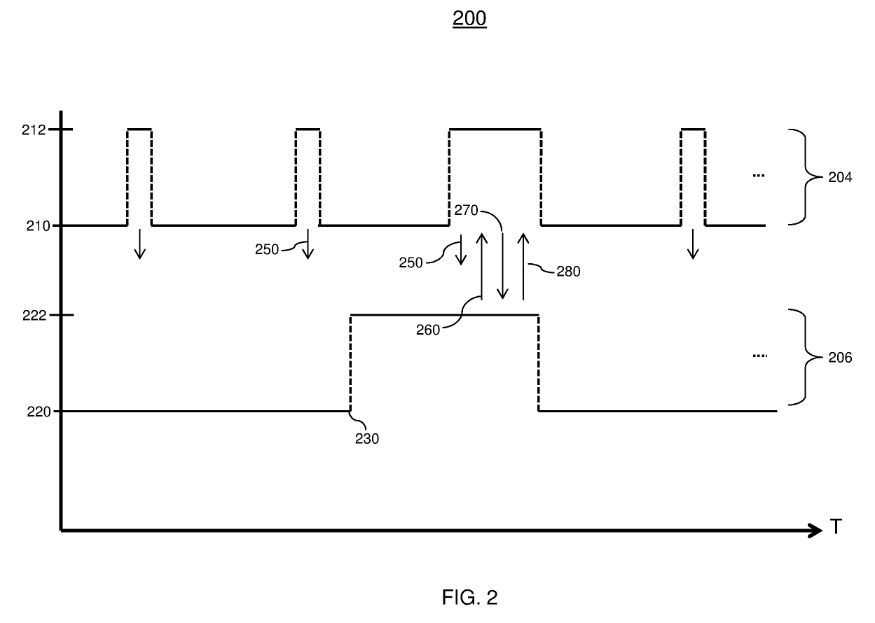

Now referring to FIG. 2, a timing diagram 200 for efficient energy management for wireless pressure indication in accordance with one or more embodiments is provided. FIG. 2 provides an example for a normal transmission sequence.

The timing diagram 200 illustrates the interaction between a WPS 204 and WPI 206. The diagram 200 includes 2 states for the WPS 204 and WPI 206, sleep state 210, 220 and awake/active state 212, 222. The WPS 204 transitions between the sleep state 210 and the awake state 212, and the WPI 206 transitions between the sleep state 220 and the awake state 222.

The WPS 204 periodically enters the awake state 212 and transmits an awake message or probe or request to the WPI 206. In one or more embodiments, the WPS 204 wakes up at 5 second intervals and remains awake for 10 milliseconds at a time. In other embodiments, the intervals and the awake duration can be configured according to the needs of the system. During each interval the awake message 250 or probe is transmitted to the WPI 206 to determine if the WPI 206 is in the sleep state 220 or the awake state 222. In one or more embodiments, the WPI 206 can enter the awake state 222 based on a user request.

In the event, the WPI 206 is in sleep state 220, the WPS 204 continues to periodically transmit the awake message 250 until it is determined the WPI 206 is in the awake state 222. In the event, the WPI 206 enters the awake state 222 when it receives a request 230 from a user. After the WPI 206 enters the awake state 222 and receives an awake message 250 from the WPS 204, the WPI 206 transmits a reply 260.

After the WPS 204 receives the reply message 260, it enters and active state to performs the detection operation for the sensor, and transmits the sensor information 270 to the WPI 206. After the WPI 206 receives the sensor information 270, it transmits an acknowledgment 280 to the WPS 204 prior to returning to sleep state 220. Also, responsive to receiving the sensor information 270, the WPI 206 can display the sensor information 270 to a user. After the WPS 204 receives the acknowledgment 280, the WPS 204 returns to the sleep state 210 and continues to periodically transmit the awake messages 250.

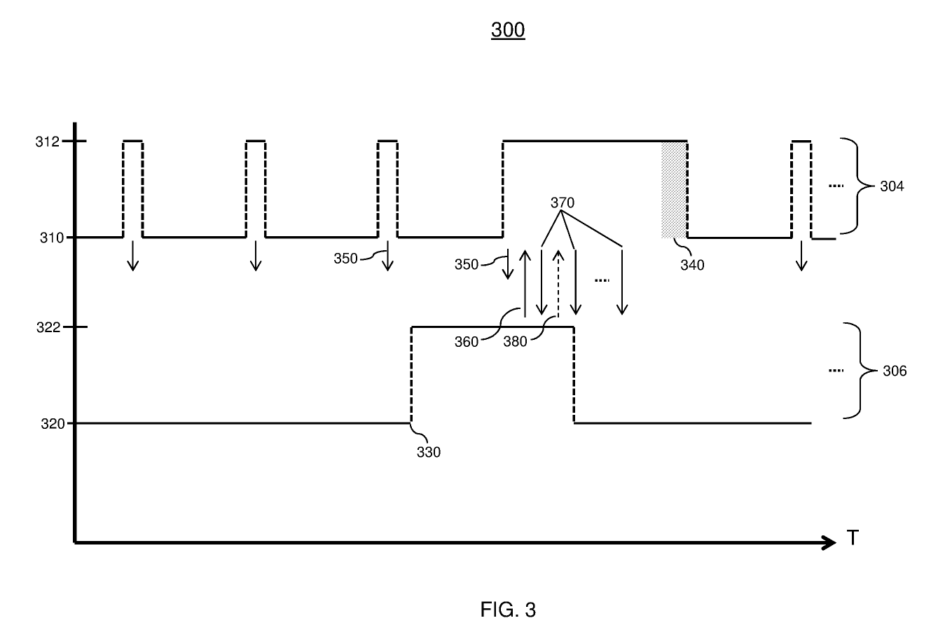

Now referring to FIG. 3, a timing diagram 300 for efficient energy management for wireless pressure indication in accordance with one or more embodiments is provided. FIG. 3 provides an example for a missed WPI acknowledgment sequence.

The WPS 304 and the WPI 320 can transition between the sleep state 310, 320 and the awake state 312, 322. In one or more embodiments, the WPI 306 enters the awake state 322 when it receives a request 330. After the WPS 306 enters the awake state 322 the WPI 306 can periodically sends an awake message 350 to determine if the WPI is in an awake state 322. When the WPI 306 receives the awake message 350 it transmits a reply message 360 to the WPS 304 to indicate that it is in the awake state 322.

Responsive to receiving the reply message 360 the WPS 304 enters into an active state and performs a detection operation to obtain the present condition of the sensor. The sensor information 370 is then transmitted to the WPI 306. Responsive to receiving the sensor information 370 the WPI 306 transmits an acknowledgment message 380 to the WPS 304.

In the event the WPS 304 misses the acknowledgment message 380 (as shown in FIG. 3), the WPS 304 can retransmit the sensor information 370. For example, if the acknowledgment (ACK) to the sensor data (the pressure, temperature, and battery information) has not been received, the WPS can continue to retransmit the sensor data until an ACK is received from the WPI. In another embodiment, the retransmission of the sensor data can be limited to a configurable number of attempts (i.e. two times). The number of retransmit attempts can be limited to conserve the power resources of the system. In one or more embodiments, after performing the retransmissions the WPS 304 can enter a timeout period 340 prior to returning to the sleep state 310.

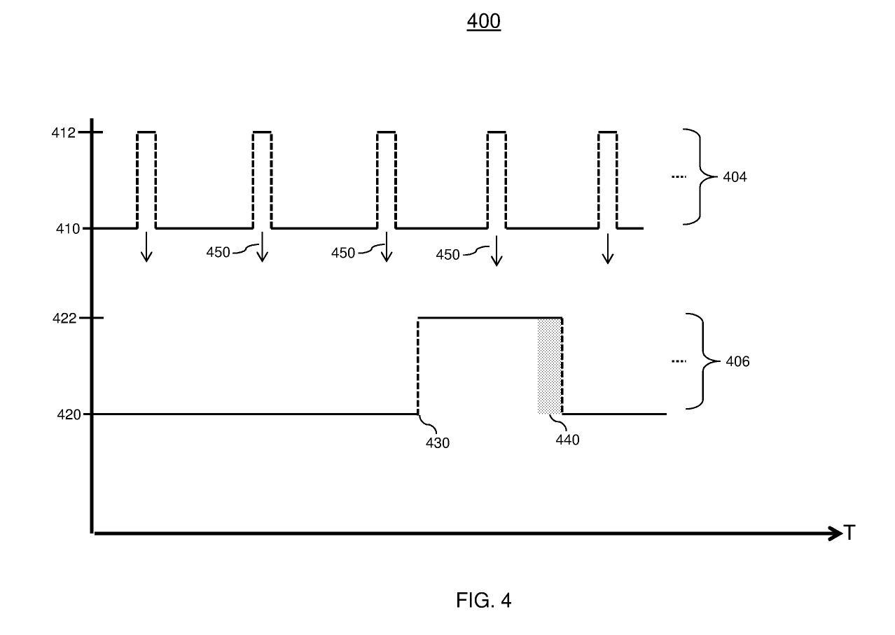

Now referring to FIG. 4, a timing diagram 400 for efficient energy management for wireless pressure indication in accordance with one or more embodiments is provided. FIG. 4 provides an example for a missed WPS packet sequence.

The WPS 404 and the WPI 406 can transition between the sleep state 410, 420 and the awake state 412, 422. The WPS 404 enters the awake state 412 and transmits an awake message 450 to the WPI 406. In one or more embodiments, the WPI 406 enters the awake state 422 when it receives a request 430 from a user. After the WPI 420 remains in the awake state 422, it expects to receive an awake message 450 or packet from the WPS 406. In the example shown in FIG. 4, the WPI 406 missed the awake message 450 and remains in the awake state 422 for an additional timeout period 440 before returning to the sleep state 420. In one or more embodiments, the timeout period 440 is a configurable period.

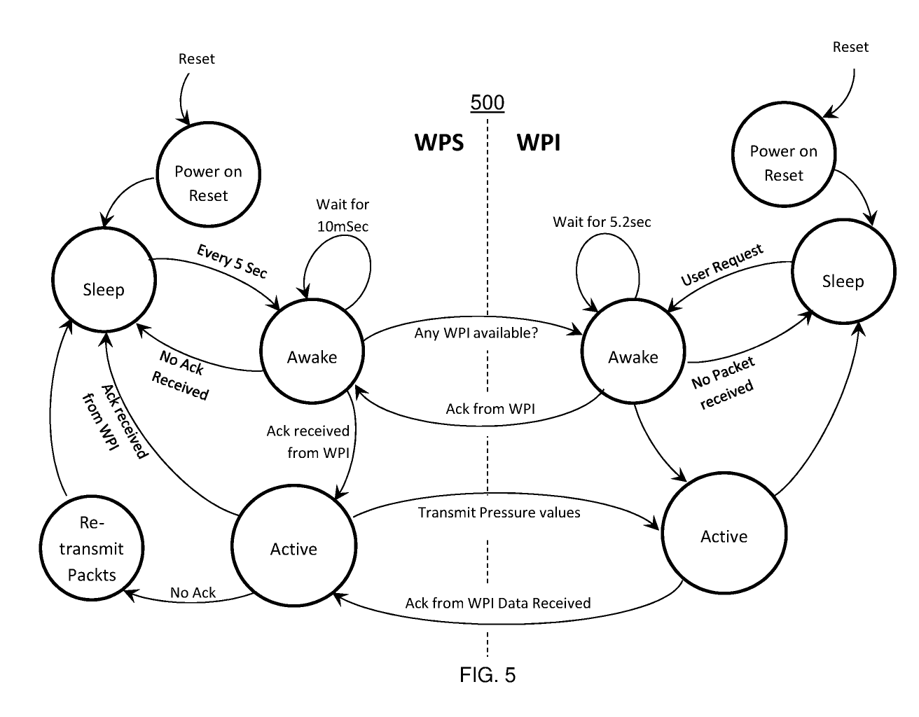

Now referring to FIG. 5, a state diagram 500 for efficient energy management for wireless pressure indication in accordance with one or more embodiments is provided.

The diagram 500 illustrates a plurality of states for the WPS and the WPI. The WPS begins in the Power on/Reset state and then enters the Sleep state. The WPS enters the Awake state every 5 seconds and remains in the Awake state for 10 milliseconds at a time. During the Awake state the WPS determines whether a WPI is in an Awake state. If the WPS receives an Ack (Reply) from the WPI, the WPS enters the Active state. If not, the WPS returns to the Sleep state if no Ack has been received. In the Active state, the WPS transmit the pressures values to the WPI and awaits an Ack from the WPI indicating the data has been received. If an Ack is received, the WPS returns to the Sleep state. If an Ack is not received, the WPS can retransmit the pressure values and then returns to the Sleep state.

The diagram 500 illustrates the plurality of states for the WPI. The WPI begins the Power on/Reset state and enters the Sleep state. Upon receiving a user request the WPI enters the Awake state and waits for 5.2 seconds to receive a message from the WPS. If a packet is not received, the WPI returns to the Sleep state. If a packet is received, the WPI enters the Active state and prepares to receive the pressure values. Upon receiving the pressure values, an Ack is transmitted to the WPS and returns to the Sleep state to conserve power.

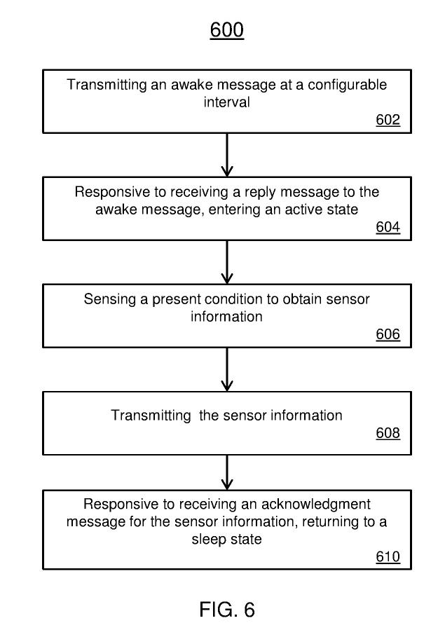

Now referring to FIG. 6, a flow diagram 600 for operating a wireless pressure sensor for efficient energy management of a wireless pressure system in accordance with one or more embodiments is provided.

Block 602 provides transmitting, via a wireless pressure sensor, an awake message at configurable intervals. Block 604 provides responsive to receiving a reply message to the awake message, entering an active state. Block 606 provides sensing a present condition to obtain sensor information. In one or more embodiments, the sensor information includes at least one or more of pressure information, temperature information, and battery information. Block 608 provides transmitting the sensor information. Block 610 provides responsive to receiving an acknowledgment message for the sensor information, returning to a sleep state.

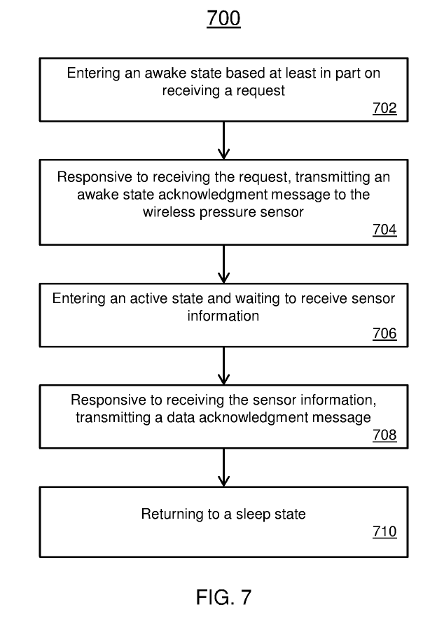

Now referring to FIG. 7, a flow diagram 700 for operating a wireless pressure indicator for efficient energy management of a wireless pressure system in accordance with one or more embodiments is provided.

Block 702 provides entering an awake state based at least in part on receiving a request. In one or more embodiments, the request can be a user request or an awake message. Block 704 provides responsive to receiving the request, transmitting an awake state acknowledgement message to the wireless pressure sensor. Block 706 provides entering an active state and waiting to receive sensor information. Block 708 provides responsive to receiving the sensor information, transmitting a data acknowledgment message. Block 710 provides returning to a sleep state.

The techniques described herein provide a small software footprint. In addition, there is a reduced resource requirement for implementation of the protocol in terms of power, execution, etc. The techniques are also scalable to the sensor networks with minimal modifications to the existing network.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A method for efficient energy management for wireless pressure indication systems, the method comprises:
transmitting, via a wireless pressure sensor device coupled to a regulator valve, an awake message at a configurable interval to a wireless pressure indicator device, wherein the wireless pressure indicator device is configured to enter a sleep mode and an awake mode;
responsive to receiving a reply message to the awake message, entering an active state;
sensing a present condition to obtain sensor information;
transmitting the sensor information; and
responsive to receiving an acknowledgment message for the sensor information, returning to a sleep state.

2. The method of claim 1, wherein the sensor information includes at least pressure information, temperature information, and battery information.

3. The method of claim 1, responsive to missing the acknowledgment message after transmitting the sensor information, retransmitting the sensor information a configurable threshold number of times prior to returning to the sleep state.

4. The method of claim 1, responsive to missing the awake message, waiting a timeout period prior to returning to the sleep state.

5. The method of claim 1, wherein a plurality of wireless pressure sensor devices is paired with a wireless pressure indicator device.

6. The method of claim 1, wherein a single wireless pressure sensor device is paired with a wireless pressure indicator device.

7. The method of claim 1, wherein transmitting the awake message is responsive to receiving a request message.

8. The method of claim 1, wherein the wireless pressure sensor device is associated with an evacuation slide.

9. A method for efficient energy management for wireless pressure indication systems, the method comprises:
receiving, via a wireless pressure indicator device, an awake message from a wireless pressure sensor device coupled to a regulator valve, responsive to the awake message, entering an active state;
responsive to receiving sensor information, transmitting an acknowledgement message; and
responsive to transmitting the acknowledgement message, the wireless pressure indicator device returns to a sleep state, wherein the wireless pressure indicator device is configured to display the sensor information.

10. The method of claim 9, wherein the sensor information includes at least pressure information, temperature information, and battery information.

11. The method of claim 9, wherein a plurality of wireless pressure sensor devices is paired with the wireless pressure indicator device.

12. The method of claim 9, wherein a single wireless pressure sensor device is paired with the wireless pressure indicator device.

13. The method of claim 9, wherein the wireless pressure indicator device enters the active state based on receiving a request.

14. The method of claim 9, wherein a wireless pressure sensor is associated with an evacuation slide.

15. A system for efficient energy management for wireless pressure indication systems, the system comprises:
a wireless pressure sensor device, wherein the wireless pressure sensor device is coupled to a regulator valve; and
a wireless pressure indicator device, wherein the wireless pressure indicator device includes a processor, a display, and a communication interface, wherein the wireless pressure sensor device is configured to transmit sensor information to the wireless pressure indicator device, wherein the wireless pressure indicator device is configured to enter a sleep mode and an awake mode.

16. The system of claim 15, wherein the wireless pressure sensor device measures an air pressure used for evacuation slides.

17. The system of claim 15, wherein the sensor information includes at least pressure information, temperature information, and battery information.

18. The system of claim 15, wherein a plurality of wireless pressure sensor devices is paired with the wireless pressure indicator device.

19. The system of claim 15, wherein a single wireless pressure sensor device is paired with the wireless pressure indicator device.
